(19) United States
(12) Patent Application Publication
(10) Pub. No.: US 2013/0155211 A1
(43) Pub. Date: Jun. 20, 2013

(54) INTERACTIVE SYSTEM AND INTERACTIVE DEVICE THEREOF

(71) Applicants: Yu-Chee Tseng, Hsinchu City (TW); Chun-Hao Wu, New Taipei City (TW)

(72) Inventors: Yu-Chee Tseng, Hsinchu City (TW); Chun-Hao Wu, New Taipei City (TW)

(73) Assignee: National Chiao Tung University, Hsinchu City (TW)

(21) Appl. No.: 13/523,853

(22) Filed: Jun. 14, 2012

(30) Foreign Application Priority Data
Dec. 20, 2011 (TW) 100147491

(51) Int. Cl. H04N 7/18

(52) U.S. Cl. 348/61; 348/E07.085

(57) ABSTRACT

An interactive system includes a display device and an interactive device. The display device includes a display module for displaying an image thereon, a S processor module and a transceiver. The interactive device includes an image capturing unit, a control unit, and a signal transceiving unit configured to communicate with the transceiver. The image capturing unit is operable to capture at least a part of the image displayed on the display module. The control unit is operable to transmit information of the captured part of the image to the transceiver via the signal transceiving unit. The processor module is operable to determine location of the interactive device relative to the image displayed on the display module based on the information of the part of the image received by the transceiver.

### CROSS-REFERENCE TO RELATED APPLICATION

This application claims priority of Taiwanese Application No 100147491, filed on Dec. 20, 2011.

### BACKGROUND OF THE INVENTION

1. Field of the Invention

The invention relates to an interactive device, more particularly to an interactive device that is configured to interact with a display device.

2. Description of the Related Art

Conventional interactive systems (e.g., Microsoft Surface and Sony atracTable) utilize a specifically designed display screen that is embedded with cameras r tracking location of objects and/or hands of a user relative to the display screen, so as to generate a display image accordingly for interacting with the user. Nonetheless, such interactive systems cannot be used with display devices other than the specifically designed display screen, and have some drawbacks such as being too heavy, high manufacturing cost and lack of portability.

### SUMMARY OF THE INVENTION

Therefore, the object of the present invention is to provide an interactive system that can alleviate the aforementioned drawbacks of the prior art.

According to a first aspect, an interactive system of the present invention comprises a display device and an interactive device.

The display device includes a display module for displaying art image thereon, a processor module coupled to the display module, and a transceiver coupled to the processor module.

The interactive device includes an image capturing unit, a control unit coupled to the image capturing unit, and a signal transceiving unit coupled to the control unit and configured to communicate with the transceiver. The image capturing unit is operable to capture at least a part of the image displayed on the display module. The control unit is operable to transmit information of the part of the image captured by the image capturing unit to the transceiver via the signal transceiving unit. The processor module is operable to determine location of the interactive device relative to the image displayed on the display module based on the information of the part of the image received by the transceiver.

According to a second aspect, an interactive system of the present invention comprises a display device and an interactive device.

The display device includes a display module for displaying an image thereon and a transceiver coupled to the display module. The interactive device includes an image capturing unit, a control unit coupled to the image capturing unit, a processor unit coupled to the control unit, and a signal transceiving unit coupled to the control unit and configured to communicate with the transceiver. The image capturing unit is operable to capture at least a part of the image displayed on the display module. The control unit is operable to control the processor unit to determine location of the interactive device relative to the image displayed on the display module based on the part of the image captured by the image capturing unit.

Another object of the present invention is to provide an interactive device that is operable to interact with a display device for achieving the effects of the aforementioned interactive system.

According to a third aspect, an interactive device of the present invention is adapted to communicate with a display device. The display device is configured to display an image thereon. The interactive device comprises an image capturing unit operable to capture at least a part of the image displayed on the display device, a control unit coupled to the image capturing unit, a feedback unit coupled to and controlled by the control unit to produce a feedback output, and a signal transceiving unit coupled to the control unit and configured to communicate with the display device.

The control unit is operable to transmit information of the part of the image captured by the image capturing unit to the display device via the signal transceiving unit. The feedback output produced by the feedback unit is based on a feedback signal that is received from the display device and that corresponds to the part of the image captured by the image capturing unit.

According to a fourth aspect, an interactive device of the present invention is adapted to communicate with display device. The display device is configured to display an image thereon. The interactive device comprises an image capturing unit, a control unit coupled to the image capturing unite a processor unit coupled to the control unit, and a signal transceiving unit coupled to the control unit and configured to communicate with the display device. The image capturing unit is operable to capture at least apart of the image displayed on the display device. The control unit is operable to control the processor unit to determine location of the interactive device, relative to the image displayed on the display device based on the part of the image captured by the image capturing unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of a first preferred embodiment of an interactive system according to the invention;

FIG. 2 is a schematic diagram of the first preferred embodiment illustrating operation during a display phase;

FIG. 3 is a schematic diagram of the first preferred embodiment illustrating operation during an identification phase;

FIG. 4 is a schematic diagram illustrating another implementation of the first preferred embodiment;

FIG. 5 is a schematic diagram of a second preferred embodiment of the interactive system, in which a feedback unit thereof displays a section of a three-dimensional computer tomography image; and

FIG. 6 is a schematic diagram of the second preferred embodiment, in which the feedback unit displays another section of a three-dimensional computer tomography image.

### DETAILED DESCRIPTION OF THE PREFERRED EMBODIMENTS

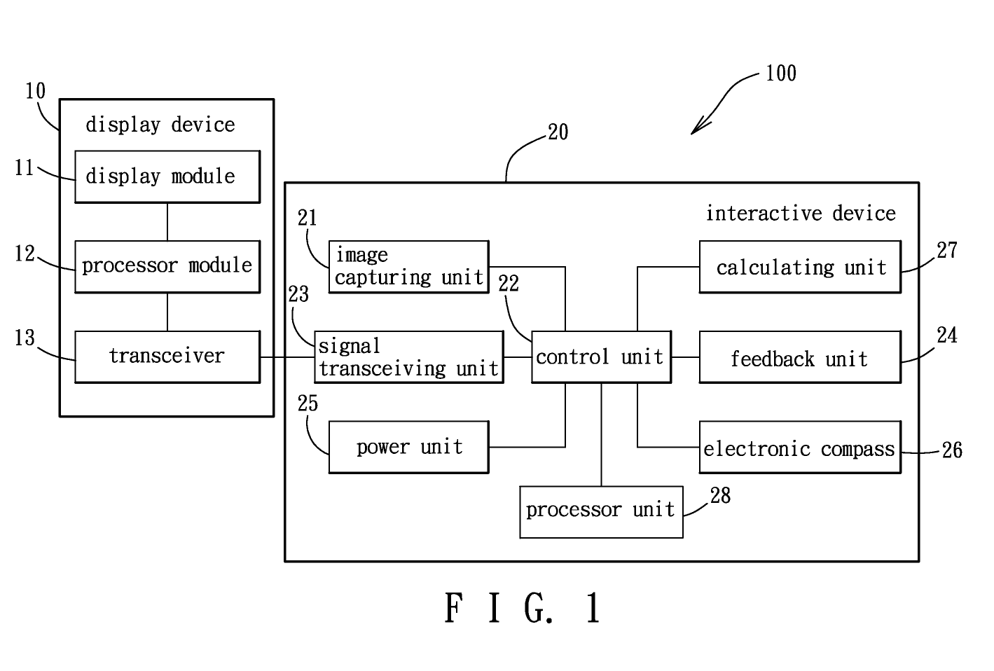

As shown in FIG. 1, the first preferred embodiment of an interactive system 100 according to the present invention comprises a display device 10 and an interactive device 20 that is con figured to communicate with the display device 10. The display device 10 can be a tablet in this embodiment, and includes a display module 11, a processor module 12 that is coupled to the display module 11, and a transceiver 13 coupled to the processor module 12.

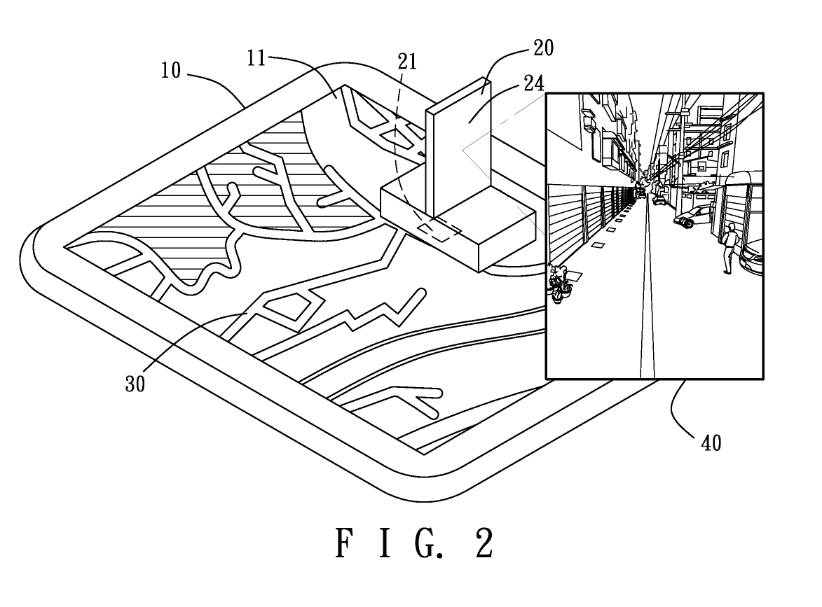

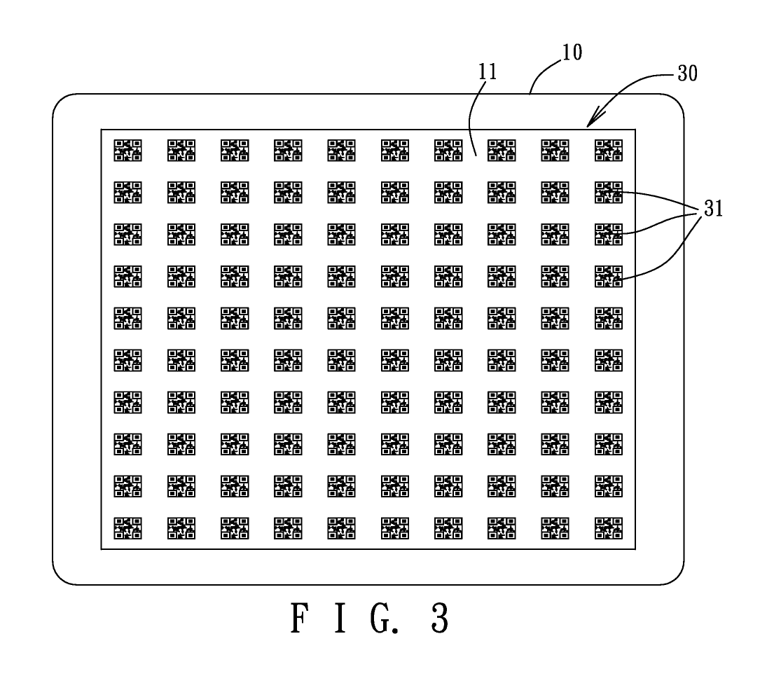

Referring to FIGS. 2 and 3, the display module 11 is for displaying an image 30 thereon. The image 30 may include any shape and color, and may be in the form of optical representations such as barcodes. The image 30 includes a plurality of identification symbols 31 (e.g., Quick Response (QR) code). The processor module 12 is operable to determine location of the interactive device 20 relative to the image 30 displayed on the display module 11 (details thereof will be described in the succeeding paragraphs). The transceiver 13 is configured to communicate with the interactive device 20 for data transmission.

The interactive device 20 includes an image capturing unit 21, a control unit 22 coupled to the image capturing unit 21, a signal transceiving unit 23 coupled to the control unit 22 and configured to communicate with the transceiver 13 (through wireless communication protocols such as Wi-Fi and Bluetooth), a feedback unit 24 and a power unit 25. It is noted that the interactive system 100 can include one or more interactive devices 20 in other embodiments. In this embodiment, the image capturing unit 21 is a camera unit with a relatively short depth of field, such as a contact image sensor. The image capturing unit 21 is configured to capture at least a part of the image displayed on the display module 11. Specifically, the part of the image 30 captured by the image capturing unit 21 includes one of the identification symbols 31 (as a result, an effective range that the image capturing unit 21 is operable to capture is preferably larger than an area of a largest one of the identification symbols 31). The control unit 22 is operable to identify the one of the identification symbols 31 in the part of the image 30 captured by the image capturing unit 21. The feedback unit 24 is coupled to and controlled by the control unit 22 to generate a feedback output based on a signal that is based on the location of the interactive device 20 relative to the image 30 displayed on the display module 11 and that is received by the signal transceiving unit 23. In this embodiment, the feedback unit 24 includes a display screen coupled to the control unit 22, such that the feedback output includes an output image that is associated with the part of the image 30 captured by the image capturing unit 21. In other embodiments, the feedback unit 24 may further include a speaker and/or a vibrator, which is/are actuated through the feedback signal. The power unit 25 is a set of batteries electrically connected to the control unit 22 for providing electricity to the components of the interactive device 20 (i.e., the image capturing unit 21, the control unit 22, the signal transceiving unit 23: and the feedback unit 24).

In this embodiment, operation of the display module 11 can be divided into a display phase and an identification phase. During the display phase, the display module 11 is operable to display a web map (e.g., a Google map) as shown in FIG. 2. During the identification phase, the display module 11 is operable to display the identification symbols 31 as shown in FIG. 3.

In one implementation, when the interactive device 20 is placed on the display module 11 motionless for a predetermined time period, the interactive device 20 activates an absolute localization procedure, in which the image capturing unit 21 captures a part of the image 30. The control unit 22 is operable to identify one of the identification symbols 31 in said part of the image 30 captured by the image capturing unit 21. When one of the identification symbols 31 is identified, the control unit 22 is operable to transmit the identified one of the identification symbols 31 to the transceiver 13 of the display device 10 via the signal transceiving unit 23. The processor module 12 of the display device 10 is operable to compare the received one of the identification symbols 31 with an electronic map, which may be built-in, so as to determine the location of the interactive device 20 relative to the image 30 displayed on the display module 11. Subsequently, the processor module 12 of the display device 10 is operable to generate a feedback signal that includes a set of coordinate information (e.g., a set of geographic latitude and longitude in this implementation) that is presented in the form of (x, y) coordinates, and information about a part of the web may that corresponds to the set of geographic latitude and longitude (e.g., a street view 40 of the part of the web map). The transceiver 13 is then operable to transmit the feedback signal to the signal transceiving unit 23. The control unit 22 of the interactive device 20 is subsequently operable to control the feedback unit 24 to produce the feedback output (i.e., display the street view 40 that corresponds to the set of geographic latitude and longitude).

Preferably, each of the identification symbols 31 is associated with a landmark in a specific region (e.g., a gas station). The precise set of geographic latitude and longitude of the landmark can be preset and stored in the processor module 12. Hence, when the one of the identification symbols 31 is identified by the control unit 22 as one of the landmarks and transmitted to the display device 10, the processor module 12 is operable to load the set of geographic latitude and longitude of the landmark and transmit the same along with the information about a part of the web map that corresponds to the set of geographic latitude and longitude to the interactive device 20 as the feedback signal.

The interactive device 20 may further include an electronic compass 26 (see FIG. 1) that is coupled to the control unit 22 for determining an included angle formed between the interactive device 20 and the magnetic meridian. The included angle is then transmitted along with the identified one of the identification symbols 31 to the display device 10. The feedback signal (i.e., the street view 40) generated by the processor module 12 of the display device 10 is therefore shifted by the included angle and transmitted to the interactive device 20 to show a shifted street view 40 thereon as the feedback output.

In this implementation, after the absolute localization procedure, when the interactive device 20 is moved from its original position on the surface of the display module 11, the interactive device 20 activates a relative localization procedure, during which the image capturing unit 21 captures a plurality of parts of the image 30 successively along the movement path of the interactive device 20. The captured parts of the image 30 are then transmitted to the display device 10, and are processed by the processor module 12 for calculating an effective displacement that corresponds to the displacement of the interactive device 20. The effective displacement and the set of geographic latitude and longitude that is associated with the original position of the interactive device 20 allow the processor module 12 to determine a new set of geographic latitude and longitude that is associated with the new position of the interactive device 20 without being required to compare each captured part of the image 30 with the electronic map, so that processing becomes more efficiently.

It is noted that the above operation during the relative localization procedure can also be performed directly by the interactive device 20. As shown in FIG. 1, the interactive device 20 may also include a calculating unit 27 that is coupled to the control unit 22. The calculating unit 27 may be operable to process the plurality of parts of the image 30 captured by the image capturing unit 21, and to calculate the effective displacement of the interactive device 20 that corresponds to the displacement on the web map.

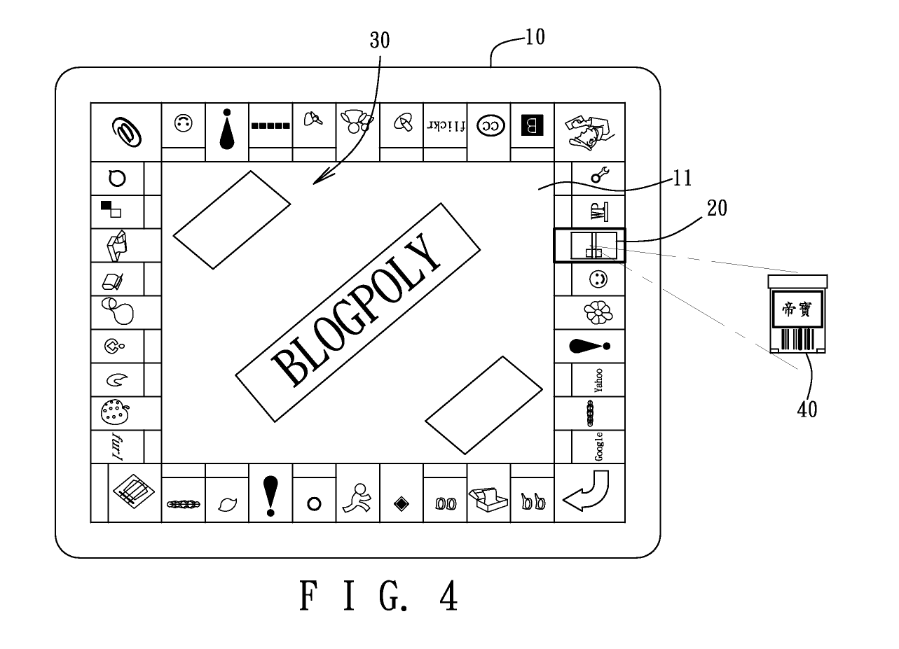

The interactive device 20 may further include a processor unit 28 (see FIG. 1) coupled to the control unit 22. In the absolute localization procedure, the control unit 22 is operable to identify one of the identification symbols 31 in the part of the image 30 captured by the image capturing unit 21 and is operable to control the processor unit 28 to determine location of the interactive device 20 relative to the image 30 displayed on the display module 11 based on the part of the image 30 captured by the image capturing unit 21. Specifically, the processor unit 28 can decode the identified one of the identification symbols 31 so as to obtain the set of geographic latitude and longitude therein. Afterward, the processor unit 28 is further operable to generate an image signal based on the location determined thereby and to transmit the image signal to the transceiver 13 via the signal transceiving unit 23. The image displayed on the display module 11 corresponds to the image signal received by the transceiver 13. It is worth noting that, when the processor unit 28 is provided in the interactive device 20, the processor module 12 is not necessarily needed to be included in the display device 10 since the determination of the location of the interactive device 20 can be made by the processor unit 28. In another implementation of this embodiment, an application (e.g., board game application) is executed, and the image 30 is associated with the application and displayed by the display module 11 as shown in FIG. 4.

In this implementation, the display module 11 is operable to display the identification symbols 31 upon determining that the interactive device 20 is placed thereon. Using the absolute localization procedure as previously described, the control unit 22 is operable to identify the one of the identification symbols 31 in the part of the image 30 captured by the image capturing unit 21 and to transmit the one of the identification symbols 31 to the transceiver 13 via the signal tranceiving unit 23. The processor module 12 is subsequently operable to determine the location of the interactive device 20 relative to the image 30 displayed on the display module 11. The transceiver 13 is then operable to transmit the feedback signal to the interactive device 20. Finally, the control unit 22 is operable to control the feedback unit 24 to produce the feedback output 40 (e.g., information about the board game).

It is worth noting that, the interactive device 20 may include the processor unit 28 for determining the location of the interactive device 20. In such case, the display module 11 includes an application unit (not shown in the Figures). The processor unit 22 is operable to transmit the location to the transceiver 13 via the signal transceiving unit 23. The application unit of the display module 11 is operable to generate an image signal corresponding to the location received by the transceiver 13. As a result, the image 30 displayed by the display module 11 corresponds to the image signal.

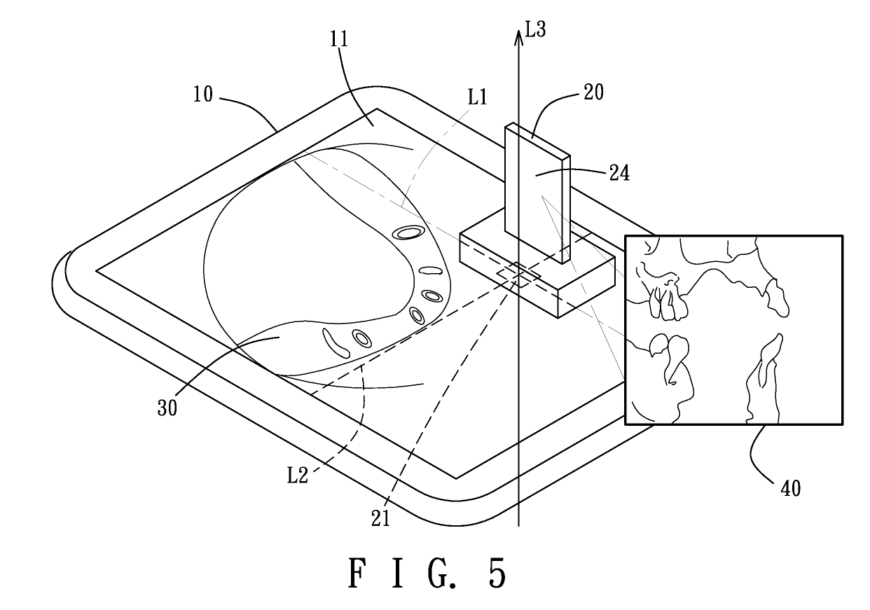

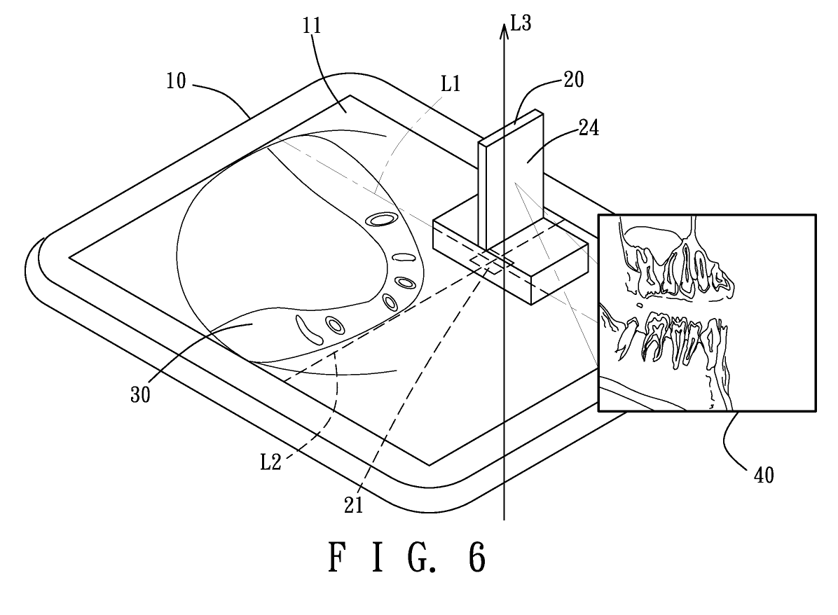

As shown in FIGS. 5 and 6, the second preferred embodiment of the interactive system 100 according to the present invention is for biomedical use. In this embodiment, the image 30 is a medical image generated by 3-D rendering techniques (such as computer tomography, magnetic resonance imaging, positron emission tomography/computer tomography) Particularly, the image 30 is exemplified as a three-dimensional computer tomography image of an oral cavity projected on a plane defined by two plane axes (i.e., L1 and L2 of FIG. 5). The interactive device 20 includes the electronic compass 26.

When the interactive device 20 is placed on the display module 11, the absolute localization procedure is activated as described in the first embodiment. As a result, the feedback signal includes the three-dimensional computer tomography image, the set of coordinate information, and the included angle formed between the interactive device 20 and the magnetic meridian. The feedback unit 24 is operable to display a section of the three-dimensional computer tomography image as the feedback output 40. The sectional view is displayed as if projected on a vertical plane defined by a vertical axis L3 and an arbitrary axis that corresponds to both the position of the interactive device 20 relative to the display device 10 and the included angle. For example, the vertical plane is defined by the axes L1 and 13 in FIG. 5, and is defined by the axes L2 and L3 in FIG. 6. The relative localization procedure allows the interactive device 20 to be further moved and rotated along the display module 11 for producing different feedback outputs about the three-dimensional computer tomography image.

To sum up, the display device 10 and the interactive device 20 of the interactive system 100 are configured to communicate with each other wirelessly, such that the location of the interactive device 20 relative to the image 30 displayed on the display module 11 can be traced accurately, and the display device 10 does not need to include additional cameras, allowing the interactive system 100 to be implemented. using various existing electronic products, and to have more portability. The interactive system 100 is also operable to allow more than one interactive device 20 to interact with the display device 10 individually.

While the present invention has been described in connection with what are considered the most practical and preferred embodiments, it is understood that this invention is not limited to the disclosed embodiment but is intended to cover various arrangements included within the spirit and scope of the broadest interpretation so as to encompass all such modifications and equivalent arrangements.

What is claimed is:

1. An interactive system comprising:
a display device including a display module for displaying an image thereon, a processor module coupled to said display module, and a transceiver coupled to said processor module; and
an interactive device including an image capturing unit, a control unit coupled to said image capturing unit, and a signal transceiving unit, coupled to said control unit, and configured to communicate with said transceiver, said image capturing unit being operable to capture at least a part of the image displayed on said display module, said control unit being operable to transmit information of said part of the image captured by said image capturing unit to said transceiver via said signal transceiving unit, said processor module being operable to determine location of said interactive device relative to the image displayed on said display module based on the information of said part of the image received by said transceiver.

2. The interactive system as claimed in claim 1, wherein the image displayed on said display module includes at least one identification symbol, said part of the image captured by said image capturing unit including the identification symbol, said control unit being operable to identify the identification symbol in said part of the image captured by said image capturing unit and to transmit the identification symbol to said transceiver via said signal tranceiving unit, said processor module being operable to determine the location of said interactive device relative to the image displayed on said display module based on the identification symbol received by said transceiver.

3. The interactive system as claimed in claim 1, wherein said processor nodule is operable to generate a signal based on the location of said interactive device relative to the image displayed on said display module and to transmit the signal to said signal transceiving unit via said transceiver, said interactive device further including a feedback unit coupled to and controlled by said control unit to produce a feedback output based on the signal received by said signal transceiving unit.

4. The interactive system as claimed in claim 3, wherein said feedback unit includes at least one of a display screen, a speaker and a vibrator.

5. The interactive system as claimed in claim 3, wherein said interactive device further includes a power unit electrically connected to said control unit for providing electricity to said image capturing unit, said control unit, said signal transceiving unit and said feedback unit.

6. An interactive system comprising:
a display device including a display module for displaying an image thereon, and a transceiver coupled to said display module; and
an interactive device including an image capturing unit, a control unit coupled to said image capturing unit, a processor unit coupled to said control unit, and a signal transceiving unit coupled to said control unit and configured to communicate with said transceiver, said image capturing unit being operable to capture at least a part of the image displayed on said display module, said control unit being operable to control said processor unit to determine location of said interactive device relative to the image displayed on said display module based on said part of the image captured by said image capturing unit.

7. The interactive system as claimed in claim 6, wherein said processor unit is further operable to generate an image signal based on the location determined thereby and to transmit the image. signal to said transceiver via said signal transceiving unit, the image displayed on said display module corresponding to the image signal received by said transceiver.

8. The interactive system as claimed in claim 6, wherein said display module includes an application unit, said processor unit being further operable to transmit the location to said transceiver via said signal transceiving unit, said application unit of said display module being operable to generate an image signal corresponding to the location received by said transceiver.

9. The interactive system as claimed in claim 8, wherein the image displayed by said display module corresponds to the image signal.

10. The interactive system as claimed in claim 8, wherein said display module is operable to transmit the image signal to said signal transceiving unit via said transceiver, said interactive device further including display screen coupled to and controlled by said control unit to produce a feedback output based on the image signal received by said signal transceiving unit.

11. The interactive system as claimed in claim 6, wherein said processor unit is operable to generate a signal based on the location of said interactive device relative to the image displayed on said display module, said interactive device further including a feedback unit coupled to and controlled by said control unit to produce a feedback output based on the signal generated by said processor unit.

12. The interactive system as claimed in claim 11, wherein said feedback unit includes, at least one of a display screen, a speaker and a vibrator.

13. The interactive system as claimed in claim 11, wherein said interactive device further includes a power unit electrically connected to said control unit for providing electricity to said image capturing unit, said control unit, said processor unit, said signal transceiving unit and said feedback unit.

14. The interactive system as claimed in claim 6, wherein the image displayed on said display module includes at least one identification symbol, said part of the image captured by said image capturing unit including the identification symbol, said control unit being operable to identify the identification symbol in said part of the image captured by said image capturing unit, said processor unit being operable to determine the location of said interactive device relative to the image displayed on said display module based on the identification symbol identified by said control unit.

15. An interactive device adapted to communicate with a display device, the display device being configured to display an image thereon, said interactive device comprising:
an image capturing unit operable to capture at least a part of the image displayed on the display device;
a control unit coupled to said image capturing unit;
a feedback unit coupled to and controlled by said control unit to produce a feedback output; and
a signal transceivinq unit coupled to said control unit and configured to communicate with the display device,
said control unit being operable to transmit information of said part of the image captured by said image capturing unit to the display device via said signal transceiving unit, said feedback output produced by said feedback unit being based on a feedback signal that is received from the display device and that corresponds to said part of the image captured by said image capturing unit.

16. The interactive device as claimed in claim 15, wherein the image displayed on the display device includes at least one identification symbol, said part of the image captured by said image capturing unit including the identification symbol, said control unit being operable to identify the identification symbol in said part of the image captured by said image capturing unit and to transmit the identification symbol to the display device via said signal tranceiving unit.

17. The interactive device as claimed in claim 16, wherein said feedback unit includes at least one of a display screen, a speaker and a vibrator.

18. The interactive device as claimed in claim 16, further comprising a power unit electrically connected to said control unit for providing electricity to said image capturing unit, said control unit, said signal transceiving unit and said feedback unit.

19. The interactive device as claimed in claim 15, further comprising a processor unit coupled to and controlled by said control unit to process said part of the image captured by said image capturing unit, and to transmit said processed part of the image to the display device via said signal tranceiving unit.

20. An interactive device adapted to communicate with a display device, the display device being configured to display an image thereon, said interactive device comprising:
an image capturing unit;
a control unit coupled to said image capturing unit;
a processor unit coupled to said control unit; and
a signal transceiving unit coupled to said control unit and configured to communicate with the display device,
said image capturing unit being operable to capture at least a part of the image displayed on the display device, said control unit being operable to control said processor unit to determine location of said interactive device relative to the image displayed on the display device based on said part of the image captured by said image capturing unit.
